(19) United States
(12) Patent Application Publication
(10) Pub. No.: US 2013/0145927 A1
(43) Pub. Date: Jun. 13, 2013

(54) Vacuum Brake Booster Having an Assembly-Friendly Chamber Arrangement and Method for Assembling Such a Vacuum Brake Booster

(71) Applicants: Hans-Martin Giese, Polch (DE); David Lopez Larequi, Koblenz (DE)

(72) Inventors: Hans-Martin Giese, Polch (DE); David Lopez Larequi, Koblenz (DE)

(73) Assignee: LUCAS AUTOMOTIVE GMBH, Koblenz (DE)

(21) Appl. No.: 13/816,989

(22) PCT Filed: Jul. 28, 2011
(86) PCT No.: PCT/EP2011/003813

§ 371 Date: Feb. 14, 2013

(30) Foreign Application Priority Data
Aug. 19, 2010 (DE) 10 2010 034 827.9

(51) Int. Cl. B60T 13/567

(52) U.S. Cl. CPC B60T 13/567
USPC 91/368; 29/888.06

(57) ABSTRACT

The invention relates to a vacuum brake booster having a chamber arrangement for producing a servo force that supports a brake actuating force, wherein the chamber arrangement comprises a housing, in which a working chamber is separated from a vacuum chamber by a movable wall, wherein the housing has a first housing shell and a second housing shell, which are or can be connected to each other in a sealing manner in a connection area, wherein a flexible section of the movable wall is arranged in a sealing manner in the connection area, and wherein the housing shells of the housing are penetrated by at least two fastening bolts in order to fasten the vacuum brake booster to a vehicle chassis. For easier assembly, at least one of the fastening bolts is provided with an engagement formation, with which one of the housing shells can be brought into engagement during the assembly, and thus said housing shell can be permanently locked in a predetermined position relative to the other housing shell.

### CROSS-REFERENCE TO RELATED APPLICATIONS

This application is a national stage of International Application No. PCT/EP2011/003813 filed Jul. 28, 2011, the disclosures of which are incorporated herein by reference in entirety, and which claimed priority to German Patent Application No. DE 10 2010 034 827.9 filed Aug. 19, 2010, the disclosures of which are incorporated herein by reference in entirety.

### BACKGROUND OF THE INVENTION

The present invention relates to a vacuum brake booster having an assembly-friendly chamber arrangement. This vacuum brake booster is provided with a chamber arrangement for producing a servo force which supports a brake actuating force, wherein the chamber arrangement comprises a housing in which a working chamber is separated from a vacuum chamber by a movable wall, wherein the housing has a first housing shell and a second housing shell which are or can be connected to one another in sealing manner in a connecting region, wherein a flexible portion of the movable wall is arranged in sealing manner in the connecting region, and wherein the housing shells of the housing are penetrated by at least two fastening bolts for fastening the vacuum brake booster to a vehicle chassis.

Vacuum brake boosters of this type are known from the prior art. It is essentially necessary to construct the housing with at least two housing shells in order to assemble the parts required for the chamber arrangement inside the housing within the framework of the assembly process. Once this assembly procedure is completed, the two housing shells have to be fixed to one another. In the further course of the assembly process, the main brake cylinder arrangement is then mounted on the vacuum brake booster and, in particular, on the projecting fastening bolts. Only then can the two housing shells be screwed and finally fixed together.

The need to fix the housing shells to one another before the assembly of the main brake cylinder arrangement has been taken into account in various ways in the prior art. Thus, for example, document EP 0 055 656 B1 discloses a vacuum brake booster and a process for the manufacture thereof in which the two housing shells are caulked in the connecting region using a complex caulking device after the assembly of the components to be arranged in the chamber arrangement. These assembly steps, in particular the caulking, are complex and costly.

A similar solution for connecting the two housing shells is known from document DE 29 42 571 A1, and corresponding U.S. Pat. No. Re. 31,911, both of which are incorporated by reference herein in entirety. With this solution, the two housing shells are also fixed to one another by complex caulking.

Document EP 2 072 362 A1 is also concerned with the need to connect the two housing shells permanently to one another during the assembly process. This document proposes using various latching connections, for example securing rings or latching lugs, or even carrying out caulking at the fastening bolts. The disadvantage of the solutions outlined in this document consist in the fact that they are also relatively complex in terms of their assembly and manufacture and can only be released with difficulty or even destructively.

### BRIEF SUMMARY OF THE INVENTION

In contrast, a feature of the present invention is to provide a vacuum brake booster of the type described at the outset and a process for its manufacture in which the two housing shells can be locked together and, if required, also unlocked again relatively easily by simple means.

This feature is achieved by a vacuum brake booster of the type described at the outset, in which provision is made for at least one of the fastening bolts to be provided with an engagement formation with which one of the housing shells can be brought into releasable engagement during the assembly process and can thus be locked in a predetermined position relative to the other housing shell.

The inventors have recognised that, instead of the complex caulking process in the connecting region of the two housing shells and also instead of attaching latching means or caulking to the fastening bolts which, to some extent, can only be released with difficulty or even destructively, the invention enables a solution which can be assembled with substantially little difficulty in that the housing shells are simply locked together, for example in accordance with the bayonet principle. Within the framework of the assembly process, it is therefore firstly possible to mount the necessary components in the interior of the chamber arrangement and then attach the second housing shell and lock it by displacing it relative to the first housing shell. Complex caulking processes on the chamber arrangement or on the fastening bolts are unnecessary. It is thus possible to dispense with a disadvantageous latching of the two housing shells using corresponding latching means which are furthermore subject to the risk of the latching forces not being sufficiently durable or the latching action becoming loose during the further assembly process.

As explained above, it is possible according to the invention for the connecting region of the two housing shells to be constructed without caulking. However, if required, local caulking can also be carried out in the connecting region at a later time.

A preferred variant embodiment of the invention provides for the engagement between the engagement formation of the at least one fasting bolt and the relevant housing shell to be effected with form fit. According to an embodiment of the invention, it is therefore possible for at least one of the fastening bolts to have a radial depression extending or running in a circumferential region. This depression can be constructed in the form of an annular groove. As an alternative to a depression, it can also be provided according to the invention for at least one of the fastening bolts to have a radial projection extending or running in a circumferential region. This can be an annular projection or a local lug. As an alternative to an engagement formation formed on the fastening bolt, according to the invention it is further possible for a retention bolt with an engagement formation to be screwed onto at least one fastening bolt or screwed into at least one fastening bolt. The retention bolt is, as it were, simply releasably screwed onto an external thread of the fastening bolt, or into an internal thread in the fastening bolt, as an additional fastening element.

To ensure that the two housing shells are locked together securely, it can be provided according to the invention for all the fastening bolts to be constructed with an engagement formation.

In terms of the construction of the housing shells, it can be provided according to the invention for corresponding receiving openings to be provided in each of the housing shells for the purpose of receiving the fastening bolts, wherein at least one of the receiving openings has a geometry which deviates from a circular shape and has at least one retention portion which can be brought into locking engagement with the engagement formation. It is possible here for the at least one receiving opening to have two diagonally opposed retention portions. This enables the locking action to be less susceptible to faults because the fitter has two devices at his disposal in which he can displace the housing shells relative to one another and thereby lock them. If the situation is again compared to the bayonet closure principle, this variant embodiment of the invention enables the bayonet closure to be locked in two directions.

As already mentioned at the outset, the invention furthermore relates to a process for assembling a vacuum brake booster of the type described above, wherein the vacuum brake booster is constructed with a chamber arrangement for producing a servo force which supports a brake actuating force, wherein the chamber arrangement comprises a housing in which a working chamber is separated from a vacuum chamber by a movable wall, wherein the housing has a first housing shell and a second housing shell which are or can be connected to one another in sealing manner in a connecting region, wherein a flexible portion of the movable wall is arranged in sealing manner in the connecting region and wherein the housing shells of the housing are penetrated by at least two fastening bolts for fastening the vacuum brake booster to a vehicle chassis, wherein at least one of the fastening bolts is furthermore provided with an engagement formation.

The process according to the invention is distinguished here by the steps:

attaching one of the housing shells to the other housing shell such that the fastening bolts each extend through associated receiving openings in the attached housing shell, and

locking the attached housing shell by a displacement relative to the other housing shell, wherein the engagement formation comes into locking engagement with the attached housing shell.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a sectional view through a chamber arrangement of a vacuum brake booster according to the invention;

FIG. 2 is a front view of the left housing shell of the chamber arrangement, as seen in FIG. 1;

FIG. 3 is an enlarged partial view of a receiving opening in the housing shell of FIG. 2;

FIG. 4 is an alternative construction of the geometry of the of the receiving opening to that in FIG. 3;

FIG. 5 is an illustration of one end of a fastening bolt when the housing shell is attached;

FIG. 6 is a view to explain the locking of the housing shell;

FIG. 7 is the result of locking the housing shell in the view according to FIG. 5;

FIG. 8 is a view according to FIG. 7 of an alternative embodiment of the fastening bolt;

FIG. 9 is a view according to FIG. 6 after the locking procedure;

FIG. 10 is a view of a further alternative embodiment of a fastening bolt; and

FIG. 11 is a view of a further alternative embodiment of a fastening bolt.

### DETAILED DESCRIPTION OF THE INVENTION

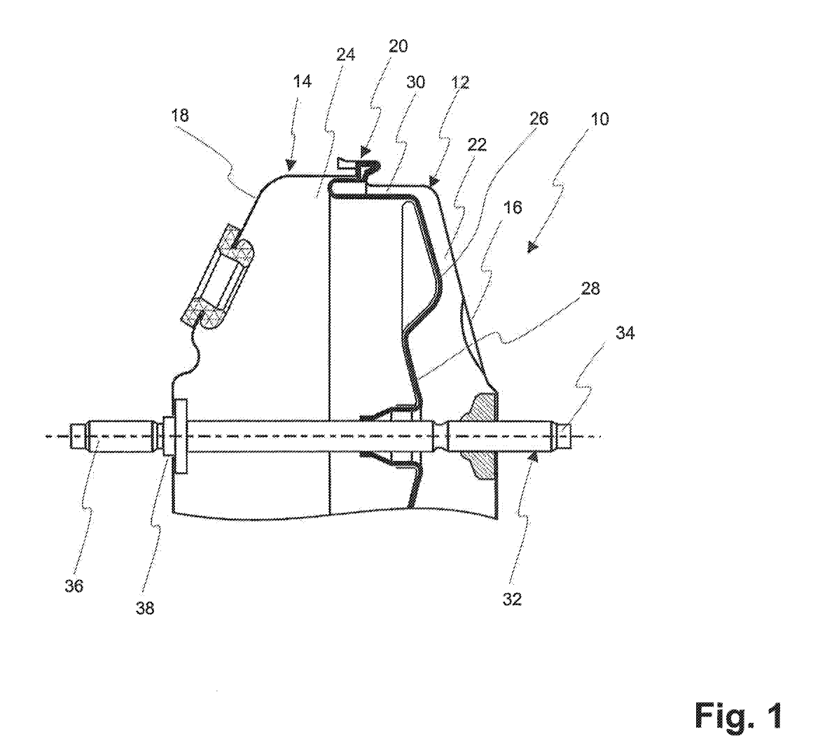

FIG. 1 shows a sectional part of a vacuum brake booster which is denoted as a whole by 10. A chamber arrangement 12, which is received in a housing 14, is shown particularly clearly in FIG. 1. The housing 14 comprises a first housing shell 16 and a second housing shell 18. These are connected to one another in a connecting region 20, but without caulking—instead merely being placed inside one another.

In the interior of the housing 14, the chamber arrangement comprises a working chamber 22 and a vacuum chamber 24. The working chamber 22 is separated from the vacuum chamber 24 by a movable wall 26. The movable wall 26 has a dimensionally stable portion 28 and is provided in its radial outer region with a flexible portion 30 which is clamped in sealing manner between the two housing shells 16 and 18 in the connecting region 20.

It can be seen in FIG. 1 that the housing 14 is penetrated by two fastening bolts 32 (only one is shown), which project with their two axial ends 34, 36 out of the housing 14. The axial end 34 serves for attachment to the vehicle chassis, in particular to the bulkhead of the vehicle body. The axial end 36 serves for fastening the main brake cylinder arrangement (not shown).

For assembly, the housing shell 16 is firstly used to mount individual components therein or thereon, such as the movable wall 26 with a control valve arrangement (not shown), and the fastening bolts 32. The second housing shell 18 is then attached. In the prior art, either caulking was carried out in the connecting region or complex securing measures were applied in the region 38 on the fastening bolts, for example latching means.

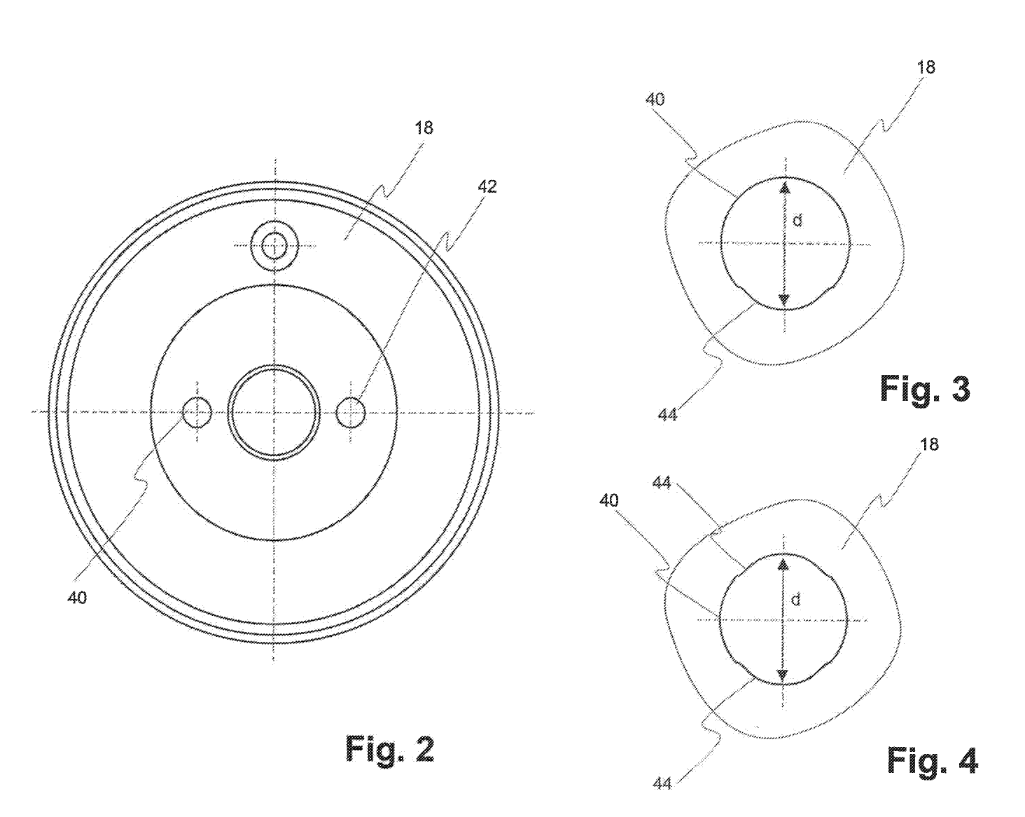

In this connection, in a first embodiment of the invention according to FIG. 2, it is on the other hand provided for the housing shell 18 to be constructed with special receiving openings 40, 42. FIG. 3 shows a receiving opening of this type in an enlarged view. The receiving opening 40 is not of a circular construction, but has a radially inwardly extending retention portion 44. This is provided to arrive in locking engagement with an engagement formation of the fastening bolt 32, as explained in detail below. The receiving opening has a corresponding retention portion in its upper region.

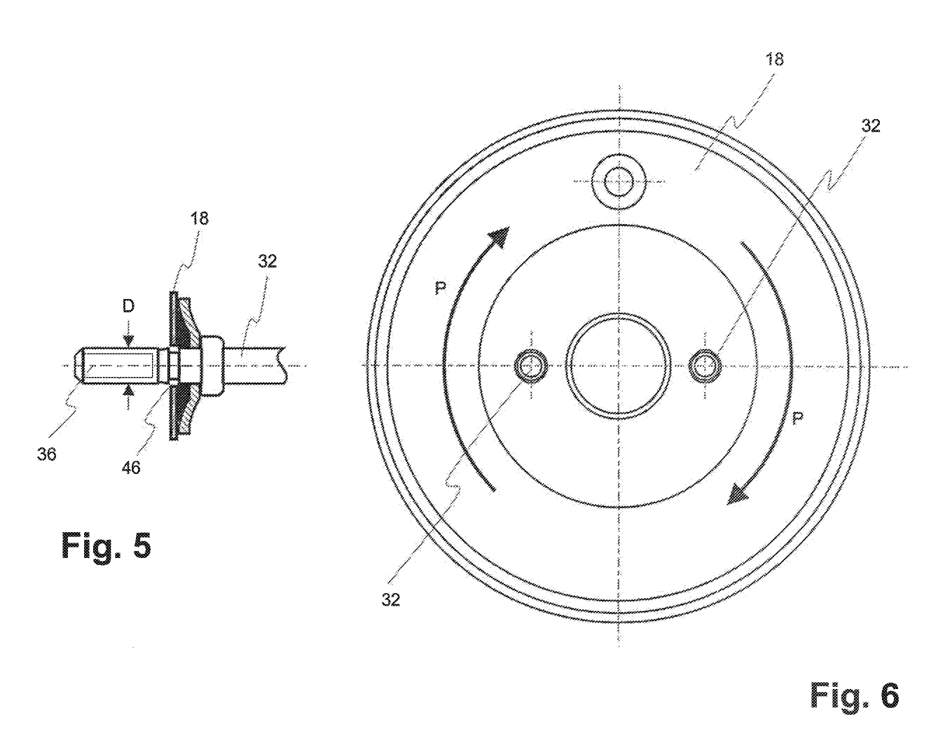

FIG. 5 shows that a circumferential groove is provided at the left end 36 of the fastening bolt 32. The diameter D of the fastening bolt 32 at this left end 36 is selected such that it can still be inserted through the receiving opening 40 according to FIG. 3 in spite of the radially inwardly projecting retention portion 44.

FIG. 6 shows the state achieved after the insertion procedure. For further assembly, the housing shell 18 is now rotated clockwise according to the arrows P relative to the other housing shell 16 and the fastening bolts 32. This relative displacement amounts to a fixing action of a bayonet closure.

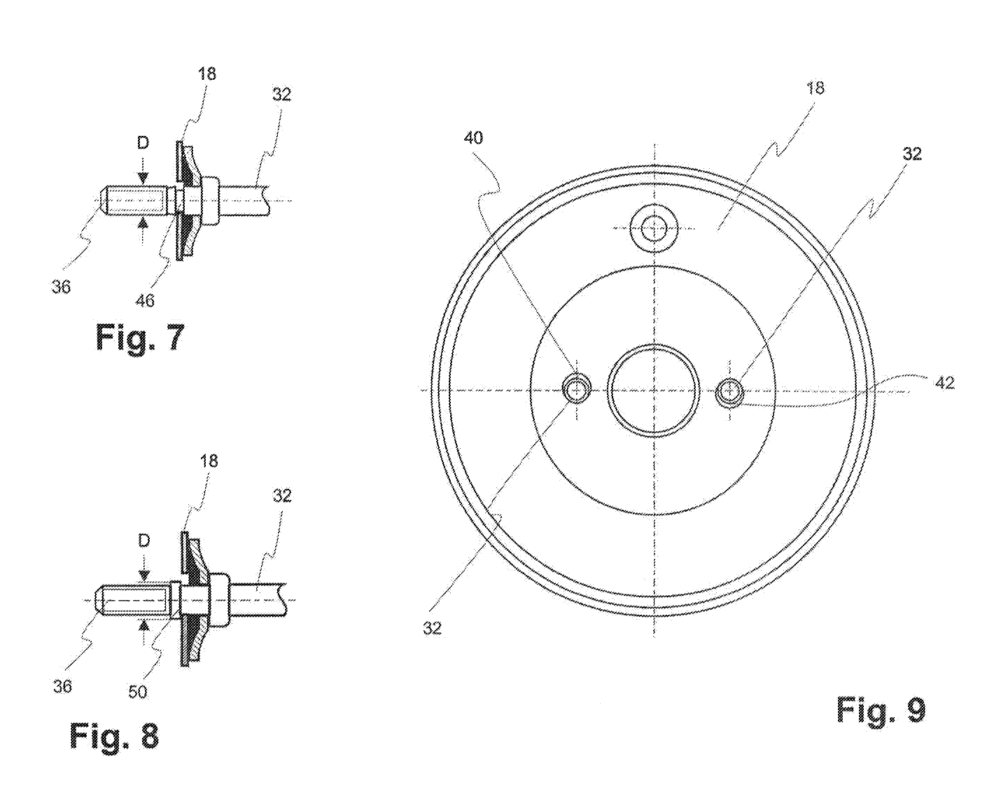

The state according to FIG. 9 is achieved as a result of the rotation according to the arrow P. Here, the retention portions of the receiving openings 40 and 42, as shown in the sectional view of FIG. 7, each engage in the groove 46 of the fastening bolt 32 so that the housing shell 18 can no longer be released in the axial direction.

However, this locking mechanism, which can be assembled easily, can be released again by rotating the housing shell 18 in the opposite direction to the arrows P, i.e. counter-clockwise. Therefore, this is not permanent locking, which can only be released with relatively great difficulty or even destructively.

FIG. 4 shows a modification to the design of the receiving opening 40 according to FIG. 3. In the embodiment shown in FIG. 4, two retention portions 44 arranged diagonally to one another, i.e. opposite one another, are provided. This enables the fitter to rotate the housing shell 18 relative to the housing shell 16 both clockwise and counter-clockwise to effectively establish the locking action. It goes without saying that the smallest diameter of the receiving opening 40 according to FIG. 4 is still sufficient to push through the fastening bolt with its end 36.

FIG. 8 shows an embodiment which has been modified with respect to the embodiment according to FIGS. 5 and 7 in terms of the design of the bolt end 36. Instead of a groove, an annular projection 50 is provided here. The external diameter of the projection 50 is selected such that it is smaller in each case than the smallest diameter of the respective receiving opening 40 (inclusive of retention portion(s) 44). With an annular projection 50 of this type, it is also possible to achieve a locking action as shown in FIG. 9.

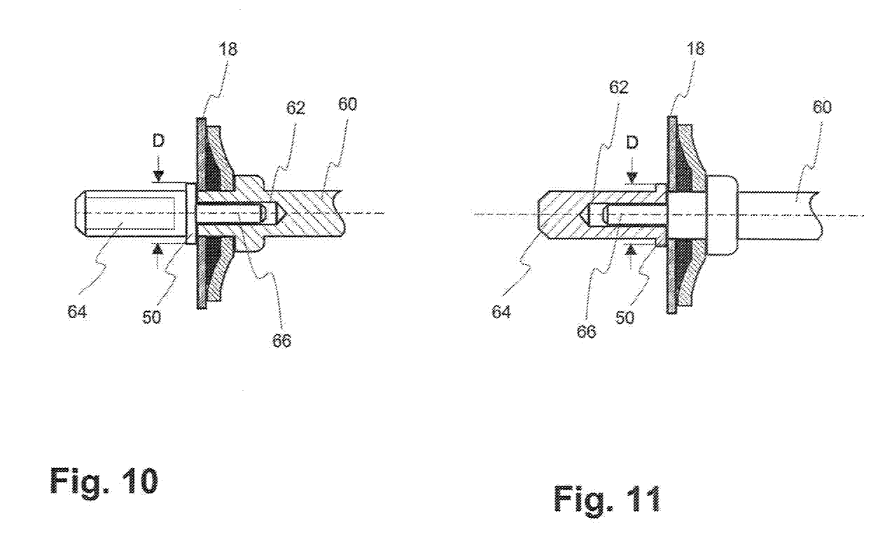

The embodiment according to FIG. 10 shows that the fastening bolt 60 can be of a shorter construction and be provided with a threaded bore 62 at its axial end. After attaching the housing shell 18, a correspondingly constructed bolt portion 64, on which a threaded pin 66 is formed, is screwed into the threaded bore 62. The bolt portion 64 also has an annular projection 50 for fixing the housing shell 18 in position.

Finally, the embodiment according to FIG. 11 shows a modification with respect to the embodiment according to FIG. 10. The threaded pin 66 here is mounted on the fastening bolt 60 and the bolt portion 64 is screwed on the threaded pin 66 by means of a corresponding threaded bore 62. The housing shell 18 is in turn held by way of an annular projection 50.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A vacuum brake booster (10) having a chamber arrangement (12) for producing a servo force which supports a brake actuating force, wherein the chamber arrangement (12) comprises a housing (14) in which a working chamber (22) is separated from a vacuum chamber (24) by a movable wall (26), wherein the housing (14) has a first housing shell (16) and a second housing shell (18), which are or can be connected to one another in sealing manner in a connecting region (20), wherein a flexible portion (30) of the movable wall (26) is arranged in sealing manner in the connecting region (20), and wherein the housing shells (16, 18) of the housing (14) are penetrated by at least two fastening bolts (32) for fastening the vacuum brake booster (10) to a vehicle chassis,
characterised in that at least one of the fastening bolts (32) is provided with an engagement formation (46, 50) with which one of the housing shells (16) can be brought into engagement during the assembly and can thus be permanently locked in a predetermined position relative to the other housing shell (18).

2. A vacuum brake booster (10) according to claim 1, characterised in that the connecting region (20) of the two housing shells (16, 18) is constructed without caulking.

3. A vacuum brake booster (10) according to claim 1 or 2, characterised in that the engagement between the engagement formation (46, 50) of the at least one fastening bolt (32) and the relevant housing shell (16, 18) is effected with form fit.

4. A vacuum brake booster (10) according to one of claims 1 to 3, characterised in that at least one of the fastening bolts (32) has a radial depression (46) extending or running in a circumferential region.

5. A vacuum brake booster (10) according to one of claims 1 to 3, characterised in that at least one of the fastening bolts (32) has a radial projection (50) extending or running in a circumferential region.

6. A vacuum brake booster (10) according to one of claims 1 to 3, characterised in that a retention bolt (64) with an engagement formation (46, 50) can be screwed onto at least one fastening bolt (32) or screwed into at least one fastening bolt (32).

7. A vacuum brake booster (10) according to one of the preceding claims, characterised in that all the fastening bolts (32) are constructed with an engagement formation (46, 50).

8. A vacuum brake booster (10) according to one of the preceding claims, characterised in that, for receiving the fastening bolts (32), corresponding receiving openings (40, 42) are provided in each of the housing shells (16, 18), wherein at least one of the receiving openings has a geometry which deviates from a circular shape and has at least one retention portion (44) which can be brought into locking engagement with the engagement formation (46, 50).

9. A vacuum brake booster (10) according to claim 8, characterised in that the at least one receiving opening (40, 42) has two diagonally opposed retention portions (44).

10. A process for assembling a vacuum brake booster according to one of the preceding claims, wherein the vacuum brake booster (10) is constructed with a chamber arrangement (12) for producing a servo force which supports a brake actuating force, wherein the chamber arrangement (12) comprises a housing (14) in which a working chamber (22) is separated from a vacuum chamber (24) by a movable wall (26), wherein the housing (14) has a first housing shell (16) and a second housing shell (18) which are or can be connected to one another in sealing manner in a connecting region (20), wherein a flexible portion of the movable wall (26) is arranged in sealing manner in the connecting region (20), and wherein the housing shells (16, 18) of the housing are penetrated by at least two fastening bolts (32) for fastening the vacuum brake booster (10) to a vehicle chassis, wherein at least one of the fastening bolts (32) is furthermore provided with an engagement formation (46, 50),
wherein the process is characterised by the steps:
attaching one of the housing shells (16) to the other housing shell (18) such that the fastening bolts (32) each extend through associated receiving openings (40, 42) in the attached housing shell (16, 18), and
locking the attached housing shell (16) by a displacement relative to the other housing shell (18), wherein the engagement formation (46, 50) comes into locking engagement with the attached housing shell (16, 18).
